(19) United States
(12) Patent Application Publication
(10) Pub. No.: US 2008/0079249 A1
(43) Pub. Date: Apr. 3, 2008

(54) Side airbag apparatus

(75) Inventor: Daisuke Yamamura, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/902,986

(22) Filed: Sep. 27, 2007

(30) Foreign Application Priority Data
Oct. 2, 2006 (JP) 2006-270868

(51) Int. Cl. B60R 21/207

(52) U.S. Cl. 280/730.2

(57) ABSTRACT

A side airbag apparatus includes an inflator and an airbag that is inflated and deployed by gas generated by the inflator to protect an occupant seated on a seat. The airbag includes a lumbar region protecting section, which primarily protects the lumbar region of the occupant. Prior to the inflation and deployment, the airbag is accommodated in the backrest in a state where a part including the lumbar region protecting section is folded back in a direction toward the rear of the vehicle. This configuration prevents the inflation of the airbag from being hindered and allows the airbag to properly protect the lumbar region of the occupant.

### BACKGROUND OF THE INVENTION

The present invention relates to a side airbag apparatus for protecting an occupant seated on a seat in the passenger compartment of a vehicle.

The type of side airbag apparatus as disclosed in Japanese Laid-Open Patent Publication No. 2005-047471 is commonly known. This type of side airbag apparatus has an airbag that is inflated and deployed in an emergency to protect a part of the body of an occupant seated on a seat from the thorax to the lumbar region. Prior to inflation and deployment, the airbag is accommodated in a backrest of the seat in a folded state. Specifically, an upper portion of the airbag, which includes a thorax protecting section for primarily protecting the occupant's thorax, and a lower portion of the airbag, which includes a lumbar region protecting section for primarily protecting the occupant's lumbar region, are each folded on to a center portion of the airbag. Then, the airbag is further folded along vertically extending fold lines to form an accordion-like shape. When supplied with gas from an inflator, the airbag folded in the above manner is first unfolded toward the front of the vehicle in the accordion-folded portion. Then, as the accordion-folded portion is unfolded, the folded back upper and lower portions of the airbag are unfolded.

Focusing on the lower portion of the airbag, which includes the lumbar region protecting section, the lower portion is inflated and deployed downward. Therefore, if an obstacle such as a piece of baggage placed on the seat exists in the way of inflation and deployment of the airbag lower portion, the airbag press the obstacle downward. In this case, the inflation of the airbag lower portion is hampered by the obstacle. This can cause the airbag to insufficiently protect the lumbar region of the occupant.

### SUMMARY OF THE INVENTION

Accordingly, it is an objective of the present invention to provide an airbag apparatus that prevents the inflation of an airbag from being hampered, thereby properly protecting the lumbar region of an occupant by the airbag.

To achieve the foregoing objective and in accordance with one aspect of the present invention, a side airbag apparatus for a vehicle is provided. The vehicle has in a passenger compartment a seat including a backrest. The apparatus includes an inflator and an airbag that is inflated and deployed by gas generated by the inflator to protect an occupant seated on the seat. The airbag includes a lumbar region protecting section that primarily protect the lumbar region of the occupant. Prior to the inflation and deployment, the airbag is accommodated in the backrest in a state where a part including the lumbar region protecting section is folded back in a direction toward the rear of the vehicle.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a side view illustrating a side airbag apparatus according to one embodiment of the present invention, in a state where an airbag is inflated and deployed;

FIG. 1B is a side view illustrating the side airbag apparatus of FIG. 1A, in a state where the airbag is accommodated in a backrest;

FIG. 2 is a cross-sectional view taken along line A-A of FIG. 1A;

FIG. 3 is a cross-sectional view taken along line B-B of FIG. 1A;

FIGS. 4, 5, and 6 are perspective views for explaining a folding procedure of the airbag of the side airbag apparatus shown in FIG. 1A;

FIGS. 7A and 7B are a bottom view and a side view illustrating a portion of the side airbag apparatus shown in FIG. 1A at which the airbag and an inflator are attached to the backrest;

FIG. 8 is a perspective view illustrating an airbag in a folded state of a side airbag apparatus according to another embodiment of the present invention; and

FIGS. 9A and 9B are a side view and a bottom view illustrating a portion of a side airbag apparatus according to another embodiment of the present invention at which an airbag and an inflator are attached to a backrest.

### DETAILED DESCRIPTION OF THE PREFERRED EMBODIMENTS

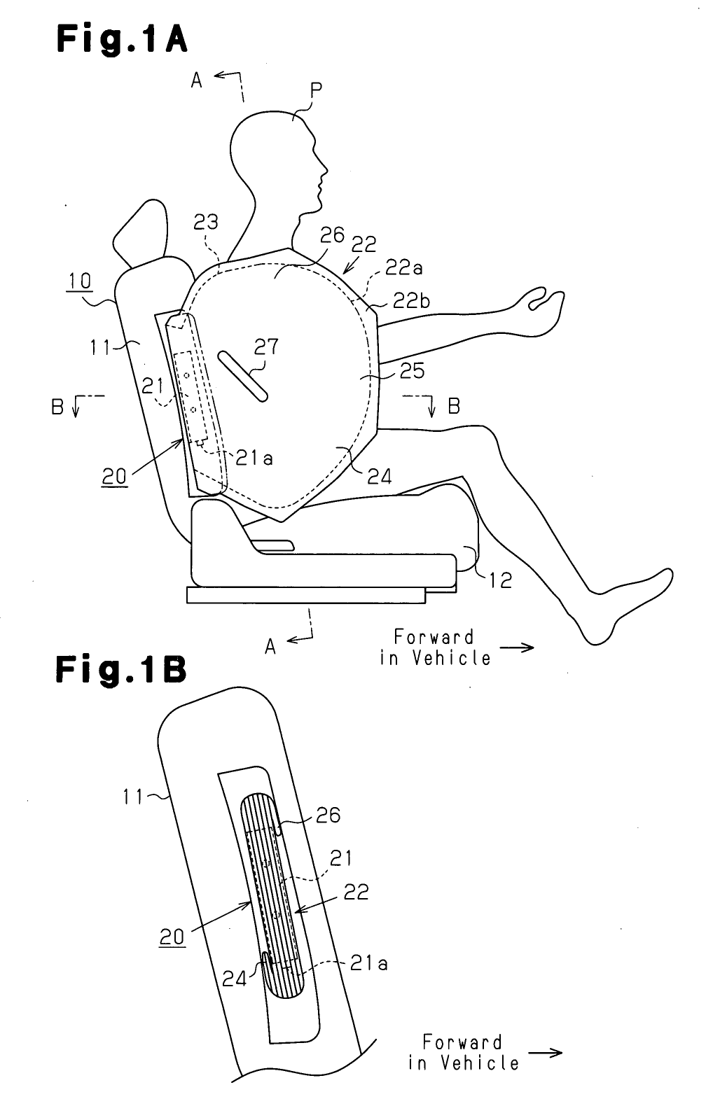

A side airbag apparatus 20 according to one embodiment of the present invention will now be described with reference to FIGS. 1A to 7B.

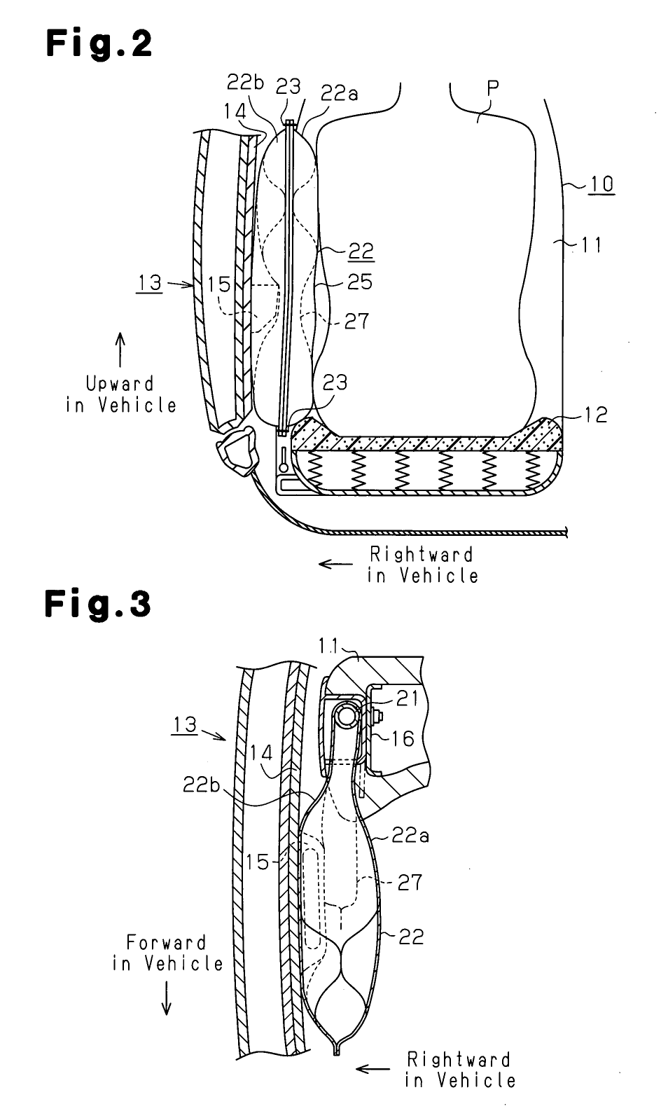

As shown in FIG. 1A, a seat 10 located in the passenger compartment of a vehicle includes a backrest 11 supporting the back of an occupant P and a seat cushion 12 supporting the buttocks of the occupant P. The side airbag apparatus 20 is accommodated in a side portion of the backrest 11. The side airbag apparatus 20 has an inflator 21 and an airbag 22. When an impact sensor (not shown) detects that the magnitude of an impact applied to a vehicle side portion 13 (see FIG. 2) is not less than a predetermined value, the inflator 21 generates gas. The gas generated by the inflator 21 inflates and deploys the airbag 22 between an occupant P seated on the seat 10 and a side portion 14 (see FIG. 2) of inner walls defining the passenger compartment. This prevents the occupant P from contacting the inner wall side portion 14, so that the impact applied to the occupant P is reduced. That is, the occupant P on the seat 10 is protected by the airbag 22.

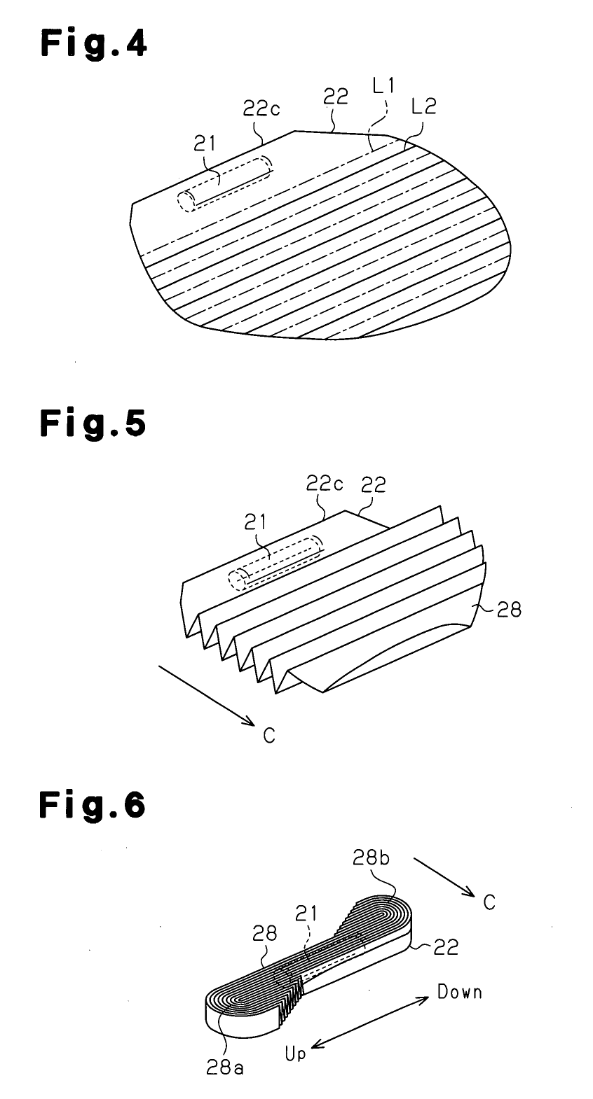

The airbag 22 is formed, for example, by sewing a pair of fire-proof flexible woven fabric sheets 22a, 22b with sewing threads 23 (see FIG. 2). The airbag 22 has a lower portion 24, which includes a lumbar region protecting section for primarily protecting the lumbar region of the occupant P, an upper portion 26, which includes a shoulder protecting section for primarily protecting a shoulder of the occupant P, and a center portion 25, which includes an abdomen protecting section for primarily protecting the abdomen of the occupant P. The airbag 22 is attached to the backrest 11 at an attachment portion 22c (see FIG. 4), which is a part of the periphery of the airbag 22. Prior to inflation and deployment, the airbag 22 is accommodated in the backrest 11 in a folded state. A method for folding the airbag 22 will be described later.

As shown in FIGS. 2 and 3, an inflation limiting seam 27 is formed in the center portion 25 of the airbag 22. When the airbag 22 is inflated and deployed, the inflation limiting seam 27 limits the flow of gas to a part of the center portion 25 that contacts a door trim 15 protruding into the passenger compartment from the inner wall side portion 14. Specifically, the inflation limiting seam 27 limits the flow of gas from the inflator 21 so that the gas flows to the lower portion 24 of the airbag 22. Accordingly, the center portion 25 of the airbag 22 is prevented from being excessively expanded, so that the center portion 25 is not strongly pressed against the abdomen of the occupant P and the door trim 15.

As shown in FIGS. 1A and 3, the inflator 21 is located in the airbag 22 such that its longitudinal axis is substantially agrees with the vertical direction. Bolts extending from the inflator 21 are inserted through and fastened to a seat frame 16 of the backrest 11, so that the inflator 21, together with the airbag 22, is fixed to the backrest 11. When the inflator 21 generates and ejects gas, the airbag 22 starts being inflated and deployed. In the present embodiment, a gas outlet 21a (see FIG. 1A) of the inflator 21 is oriented toward the lower portion 24 of the airbag 22. Thus, the gas ejected from the inflator 21 first flows into the lower portion 24 of the airbag 22, and to the center portion 25 and the upper portion 26 of the airbag 22 via the lower portion 24.

A method for folding the airbag 22 will now be described with reference to FIGS. 4 to 7B.

First, the airbag 22 is folded along valley fold lines L1 and mountain fold lines L2, which are alternately arranged at equal intervals, as shown in FIGS. 4 and 5, so that an accordion-folded portion 28 is formed. In FIG. 4, the valley fold lines L1 are shown by dashed lines, and the mountain fold lines L2 are shown by solid lines. The fold lines L1 and L2 intersect a deployment direction C of the airbag 22 shown by an arrow in FIG. 5. The deployment direction C of the airbag 22 is a direction from the side portion of the backrest 11 toward the front of the vehicle, and substantially perpendicular to the vertical direction.

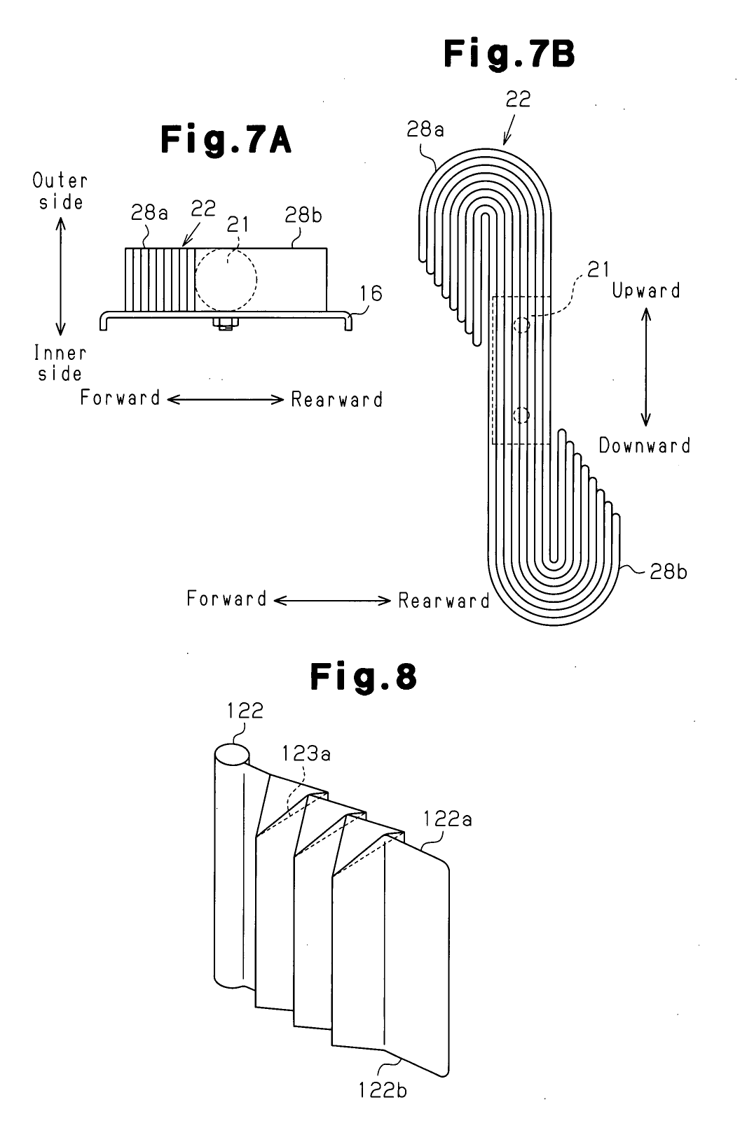

As shown in FIG. 6, a first part 28a of the accordion-folded portion 28 that corresponds to the upper portion 26 of the airbag 22 is folded back by 180 degrees in the deployment direction C, that is, toward the front of the vehicle. On the other hand, a second part 28b of the accordion-folded portion 28 that corresponds to the lower portion 24 of the airbag 22 is folded back by 180 degrees in a direction opposite to the deployment direction C, that is, toward the rear of the vehicle. The airbag 22, which has been folded in this manner, is bound by a holding member (not shown), so that the airbag 22 is not unintentionally deployed. Thereafter, as shown in FIGS. 7A and 7B, the inflator 21, together with the airbag 22, is fixed to the seat frame 16, so that the airbag 22 is accommodated in the backrest 11.

The above described side airbag apparatus 20 operates in the following manner. When the impact sensor detects that an impact equal to or greater than a predetermined value is applied to the vehicle side portion 13, an activation signal is sent to the inflator 21 through a control circuit (not shown). Based on the activation signal, the inflator 21 generates and ejects gas to the lower portion 24 of the airbag 22. The airbag 22 is inflated and deployed by the gas from the inflator 21.

More specifically, since the gas outlet 21a of the inflator 21 is oriented toward the lower portion 24 of the airbag 22, the second part 28b of the accordion-folded portion 28 that corresponds to the lower portion 24 of the airbag 22 is first inflated and deployed. During this process, the folding back of the second part 28b toward the rear of the vehicle is unfolded as a matter of course. The unfolding of the folding back of the second part 28b occurs while the lower portion 24 of the airbag 22 is still in the backrest 11. Thereafter, the lower portion 24 of the airbag 22 is inflated and deployed toward the front of the vehicle. Therefore, even if an obstacle exists in a direction of inflation and deployment of the lower portion 24 of the airbag 22, for example, on the seat cushion 12, the airbag 22 is inflated and deployed to push away the obstacle forward to an open space instead of pressing the obstacle downward against the seat cushion 12. Even if the folding back of the second part 28b is unfolded after the lower portion 24 of the airbag 22 is moved to the outside of the backrest 11, the airbag 22 is inflated and deployed forward or upward to push away the obstacle toward an open space. The center portion 25 and the upper portion 26 of the airbag 22 are inflated and deployed by gas that has flowed through the lower portion 24 of the airbag 22. In the process, the folding back of the first part 28a of the accordion-folded portion 28 toward the front of the vehicle, which corresponds to the upper portion 26 of the airbag 22, is unfolded. The main unfolding of the accordion-folded portion 28, that is, the main deployment of the airbag 22 toward the front of the vehicle, occurs after the folding backs of the first and second parts 28a, 28b of the accordion-folded portion 28 are unfolded.

The present embodiment has the following advantages.

The lower portion 24 of the airbag 22, which includes the lumbar region protecting section, is accommodated in the backrest 11 in a state folded back toward the rear of the vehicle. Therefore, even if an obstacle exists in a direction of inflation and deployment of the lower portion 24 of the airbag 22, the airbag 22 is inflated and deployed to push away the obstacle forward or upward to an open space, instead of pressing the obstacle downward. Thus, the load-applied to the obstacle by the airbag 22 and the load applied to the airbag 22 by the obstacle are reduced. If the obstacle is successfully pushed away and removed, the lumbar region of the occupant P is properly protected by the airbag 22.

The folding back of the lower portion 24 of the airbag 22 toward the rear of the vehicle is achieved by folding back the part 28b, which is a part of the accordion-folded portion 28 formed by accordion folding the airbag 22 and corresponds to the lower portion 24 of the airbag 22, toward the rear of the vehicle. The accordion-folding structure allows the airbag 22 to be rapidly inflated and deployed toward the front of the vehicle.

The upper portion 26 of the airbag 22, which includes the shoulder protecting section, is accommodated in the backrest 11 in a state folded back toward the front of the vehicle. Therefore, even if an obstacle exists in a direction of inflation and deployment of the upper portion 26 of the airbag 22, the airbag 22 is inflated and deployed to push away the obstacle forward or upward to an open space, instead of pressing the obstacle downward. Thus, the load applied to the obstacle by the airbag 22 and the load applied to the airbag 22 by the obstacle are reduced. If the obstacle is successfully pushed away and removed, the shoulder of the occupant P is properly protected by the airbag 22.

The preferred embodiment may be modified as follows.

In the above embodiment, the lower portion 24, the center portion 25, and the upper portion 26 of the airbag 22 communicate with one another. However, the boundaries of the portions 24 to 26 may be sewn or bonded so that the portions 24 to 26 of the airbag 22 do not communicate with one another. In this case, the internal pressure of each of the portions 24 to 26 of the airbag 22 may be independently determined as necessary. This configuration allows inflation and deployment of the center portion 25 and the upper portion 26 of the airbag 22 to be appropriately controlled as well as those of the lower portion 24.

The upper portion 26 of the airbag 22 does not necessarily have to be folded back toward the front of the vehicle. For example, the upper portion 26 may be tucked in the center portion 25 of the airbag 22. This type of folding is called “cactus folding.” In this case, deployment of the upper portion 26 is not started until at least the accordion-folded lower portion 24 of the airbag 22 has been unfolded. The unfolding of the accordion-folded lower portion 24 is started substantially at the same time as the folding back of the lower portion 24 toward the rear of the vehicle is unfolded. Therefore, the lower portion 24 is reliably deployed in an earlier stage than the upper portion 26. The cactus folding described in this specification may be achieved by valley folding edges 122a, 122b of the airbag 122 at fold lines 123a, which are perpendicular to the edges 122a, 122b as shown in FIG. 8.

If the airbag 22 has a relatively small volume and easily accommodated in the backrest 11, the upper portion 26 of the airbag 22 does not need to be folded back.

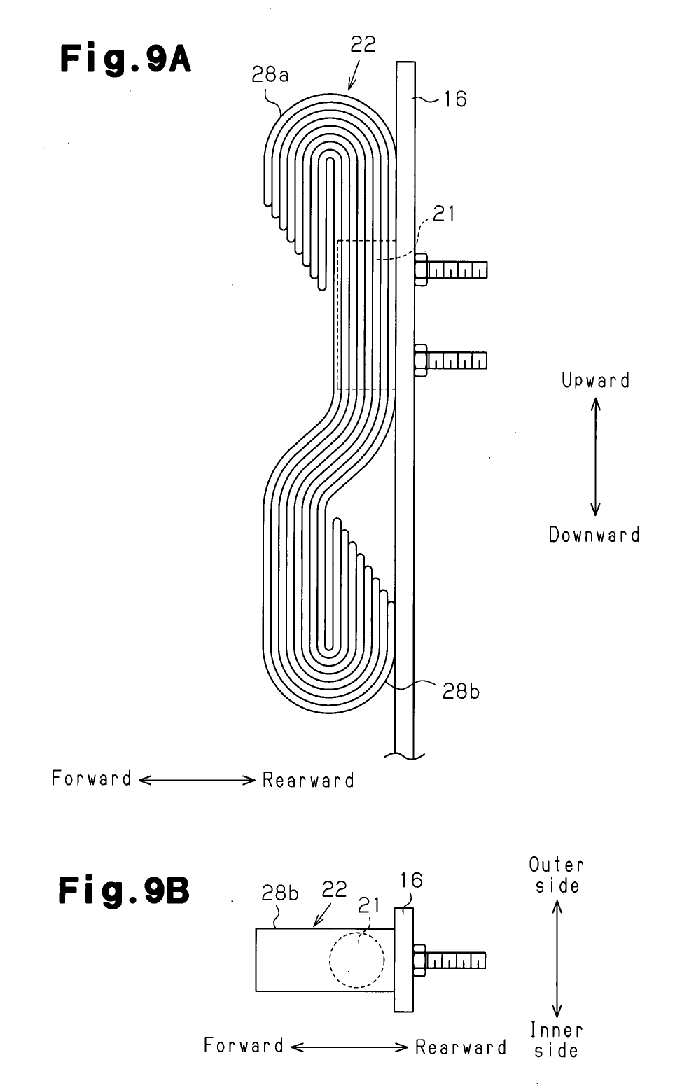

In the above embodiment, the inflator 21 and the airbag 22 are fixed to a surface of the seat frame 16 that faces a side of the vehicle. However, the inflator 21 and the airbag 22 may be fixed to a surface of the seat frame 16 that faces forward in the vehicle. In this case, the part 28b of the accordion-folded portion 28 that corresponds to the lower portion 24 of the airbag 22 is preferably folded back such that the distal end of the part 28b is located lower than the inflator 21 as shown in FIGS. 9A and 9B. This structure prevents the folded distal end of the part 28b from being stuck between the inflator 21 and the seat frame 16.

The airbag 22 of the above embodiment has the lower portion 24, which includes the lumbar region protecting section, the upper portion 26, which includes the shoulder protecting section, and the center portion 25, which includes the abdomen protecting section. However, as long as the airbag 22 has the lumbar region protecting section, the shoulder protecting section and the abdomen protecting section may be omitted.

In the above embodiment, the airbag 22 is first accordion-folded, and end portions of the accordion-folded airbag 22 are folded back. However, the folding of the airbag 22 may be carried out in the following manner. That is, the airbag 22 may be first rolled around an axis that is perpendicular to the deployment direction C of the airbag 22 or folded in half repeatedly along a fold line perpendicular to the deployment direction C of the airbag 22, and then end portions of the rolled or folded airbag 22 may be folded back.

1. A side airbag apparatus for a vehicle, the vehicle has in a passenger compartment a seat including a backrest, the apparatus comprising:
an inflator; and
an airbag that is inflated and deployed by gas generated by the inflator to protect an occupant seated on the seat, the airbag including a lumbar-region protecting section that primarily protect the lumbar region of the occupant,
wherein, prior to the inflation and deployment, the airbag is accommodated in the backrest in a state where a part including the lumbar region protecting section is folded back in a direction toward the rear of the vehicle.

2. The apparatus according to claim 1, wherein the airbag prior to the inflation and deployment is accordion-folded, and the rearward folding back of the part of the airbag that includes the lumbar region protecting section is executed by folding back, in a direction toward the rear of the vehicle, a part of the accordion-folded airbag that corresponds to the part including the lumbar region protecting section.

3. The apparatus according to claim 1, wherein the part of the airbag including the lumbar region protecting section is a first part, the airbag further having a second part that includes a section primarily protecting a part of the occupant's body that is above the lumbar region, and wherein, in the airbag prior to the inflation and deployment, the second part is tucked in a part of the airbag other than the second part.

4. The apparatus according to claim 3, wherein the first part and the second part of the airbag do not communicate with each other.

5. The apparatus according to claim 1, wherein the part including the lumbar region protecting section is a first part, the airbag further having a second part that includes a section primarily protecting a part of the occupant's body that is above the lumbar region, and wherein, in the airbag prior to the inflation and deployment, the second part is folded back in a direction toward the front of the vehicle.

6. The apparatus according to claim 5, wherein the first part and the second part of the airbag do not communicate with each other.

7. The apparatus according to claim 1, wherein the gas generated by the inflator is ejected toward the part of the airbag that includes the lumbar region protecting section.
